(19) United States
(12) Patent Application Publication
(10) Pub. No.: US 2016/0023099 A1
(43) Pub. Date: Jan. 28, 2016

(54) COGNITIVE EXERCISE SYSTEM

(71) Applicant: MEMVU, INC., Yardley, PA (US)

(72) Inventor: William M. Tymoszczuk, Perry, OH (US)

(73) Assignee: Memvu, Inc., Yardley, PA (US)

(21) Appl. No.: 14/774,782

(22) PCT Filed: Mar. 11, 2014
(86) PCT No.: PCT/US2014/023653

§ 371 Date: Sep. 11, 2015

Related U.S. Application Data
(60) Provisional application No. 61/776,772, filed on Mar. 11, 2013.

(51) Int. Cl. A63F 13/00; G06F 19/00; A63F 13/795; H04L 29/06; A63F 13/655

(52) U.S. Cl. CPC A63F 13/00; H04L 29/06034; A63F 13/655; A63F 13/795; G06F 19/3481

(57) ABSTRACT

Software system in the form of customized “games” that build, support and report on brain health and engage family members in helping to build, support, maintain brain health for a loved one suffering from a brain health condition such as Alzheimer's, a stroke or a traumatic brain injury, while providing data to evaluate treatment progress. The game includes a portion that is downloaded to a computer or mobile/wireless device for use by the patient; plus a social networking portion with an internet website customized to interconnect the patient and his support community (typically family members and close friends) in a way that encourages, enables and enhances engagement, joy and support for the patient and the community. Facilitated by the system, family and friends of the patient customize games by supplying personal photos for use as game pieces on game templates that are uniquely suited for the patient.

### CROSS-REFERENCE TO RELATED APPLICATIONS

This application claims benefit of and priority to pending U.S. Provisional Application No. 61/776,772, filed Mar. 11, 2013, which is herein incorporated by reference in its entirety.

### BACKGROUND OF THE INVENTION

There are over 5.4 million people in America living with Alzheimer's. According to the Alzheimer Association, “unless something is done, the costs of Alzheimer's in 2050 are estimated to total $1.1 trillion (in today's dollars). Cost to Medicare and Medicaid will increase nearly 500%.” Additionally, there are enormous emotional and financial tolls it takes on the caregivers of those suffering with the disease. They stated that, “In 2011, 15.2 million family members and friends provided 17.4 billion hours of unpaid care to those with Alzheimer's and other dementias—care valued at $210.5 Billion.”

More recently, due to the high incidence of traumatic brain injury in current military actions, there are a large number of patients needing brain function therapy, including cognitive brain functions.

In reviewing the literature, we see that various forms of cognitive stimulation therapy have been used in an effort to support those suffering with dementia. In one particular evidence-based program, researchers were able to show statistically significant improvements in the areas of cognition and quality of life through cognition stimulation therapy. (Reference: Spector, A. et al., Efficacy of an Evidence-Based Cognitive Stimulation Therapy Program for People with Dementia: randomized Control Trial, The British Journal of Psychiatry, vol. 183, pp. 248-254 (2003)).

It is known to use games, puzzles, mathematics and other such activities that require mental effort, thought, memory, and/or problem solving for exercising a person's cognitive (brain) functions. As physical exercise benefits body health, mental exercise is expected to be beneficial for mental health, at least in terms of cognitive ability. As with any kind of exercise, it is difficult maintain interest and motivation for continuing in a regular program at a level of difficulty needed to be beneficially effective. Even when benefits of exercise are well known, the knowledge is mostly treated like mythology—a minority rigidly adhered to it, while most simply try it when convenient, especially if so doing provides immediate benefit. Unfortunately for those who most need the exercise long term benefits are gradual and difficult to perceive well enough to find it motivating. For example, a “zealot” may attempt to memorize a book, while most people use the belief as justification for playing a (non-physical) game that they enjoy because they are reasonably successful at it. Examples would be Chess, Sudoku, trivia games, and the card game “concentration”.

Thus mental exercises have long been made more interesting by implementing them in the framework of some type of game-play selected according to whatever the player considers to be fun, enjoyable, involving, distracting, challenging, etc.—i.e., stimulating in a desirable way.

Scientific researchers are still studying the nature of cognitive ability and its relationship—beneficial or otherwise—to specific kinds and amounts of mental and/or physical actions—including physical activity, resting, and eating/nutrition for example. Research is directed at determining effective and accurate methods for discovering, defining and measuring mental activity, and furthermore attempting to isolate and focus on mental activity related to cognitive functions (thinking) versus brain activity which is related to controlling and monitoring the physical functions of the body.

Another important field of research is determining the relationships, if any, between physical illness or injury and mental activity or ability—both cognitive and body controlling. It is hoped that by understanding such relationships, there may be mental exercises/activities found that will have measurable and predictable beneficial effects on the brain or body; on the illness, injury or disability; on thought, mood, emotion, mental wellbeing, logic, calculation, memory (both short and long term), and so on.

Because the problem is so widespread and disheartening, there is a broadly felt desire to find ways to counteract the effects of cognitive decline or dementia in general, and more specifically to the severe effects of what is generally categorized as Alzheimer's disease. A major problem with aggressively progressive dementia is that it has a profound effect on family relationships and therefor the support that would otherwise be available to the same person with a physical condition. As the disease progresses, the patient loses touch with loved ones and becomes depressed. This makes it hard to treat the patient with mental exercises because they lose interest and hope. Similarly, loved ones become discouraged when the patient doesn't recognize them and no longer gives positive feedback in response to efforts to help, or when loved ones do not even know how to engage the patient.

Therefor it is an objective to develop and implement cognitive stimulation exercises that are both effective and able to maintain a patient's interest and motivation to continue their regular use at a beneficial level.

### BRIEF SUMMARY OF THE INVENTION

The present disclosure concerns a software and hardware platform (system) that utilizes social media techniques plus new forms of family (and friends) support to improve patient outcomes for those suffering from various brain health conditions/injury and to make families feel more involved and motivated in the care or recovery process. The expected outcomes from using our Cognitive Exercise System (i.e., playing our innovative brain fitness games) include an improvement in mood of the player, increased socialization, and to enhance or support other cognitive functions with an emphasis on facial recognition of family members, currency recognition and way finding by the player suffering with the brain health condition. Additional measured and reported benefits are also anticipated for the family caregivers and healthcare professionals (occupational therapists, speech therapists, recreational/activity directors, geriatric care managers and in-home care company providers) that may be administering the System.

In one aspect, the present invention provides a method for providing and encouraging patient use of a therapeutic cognitive stimulation exercise regime. In one embodiment, the method includes providing a cloud based software service, that includes a server and a website accessible to authorized participants; enrolling a support community formed of one or more of the authorized participants having a designated relationship to the patient that includes at least one of family, friends and caregivers who know the patient or who should be known by the patient; receiving from one or more of the authorized participants photos and identifying data uploaded to the server, wherein the photos include pictures of the patient's family, friends or others that were known by the patient; combining the photos with corresponding identifying data to form game pieces to be played with a selectable game template accessible via the server, to create a game customized and/or personalized for the patient; and permitting a collaboration among caregivers, the collaboration including a) cooperatively selecting the game templates for use by the patient b) selecting which of the photos to use in connection with the selected game template; and c) selecting a specific brain health function to exercise.

In one embodiment, the collaboration among caregivers further includes selecting a specific brain health function to be exercised by the patient.

In one embodiment, the method further includes providing the customized game to an interface device being used by the patient and running the customized game interactively with the patient; collecting result data indicative of the patient's game playing activity; and providing results-based feedback to the community participants based upon the result data.

In one embodiment, the result-based feedback is indicative of the patient's performance in one or more of facial recognition activities, way finding activities that includes recognition of neighborhood attributes, currency recognition ability and monetary value judgment abilities. In another embodiment, the cognitive stimulated exercise regime is developed with goals that include at least one of facial recognition reinforcement, reinforcement of way finding abilities that includes recognition of neighborhood attributes, currency recognition reinforcement and monetary value judgment reinforcement. In other embodiments, the result data include: date and time stamps for game play sessions; and one or more of identity of a selected game, a difficulty level of the selected game, a patient success rate, a patient response speed; patient age, patient gender and a patient disease condition.

In one aspect, the present invention provides a cognitive exercise system for treatment of a cognitively impaired patient, wherein the patient is associated with a support community formed of one or more caregivers who know the patient and who should be known by the patient. In one embodiment, the cognitive exercise system includes a cloud based software service that serves an internet website having: software that facilitates uploading of photographic images and associated data by the participants; software that facilitates combining the uploaded photographic images and the associated data in a game template to form game pieces in a cognitive exercise game that is customized for use by the patient; software that facilitates downloading the customized game to a patient interface device including a display for visual presentation of the game; and an interface for inputting the patient's answer selections to questions presented or responsive actions required by the game.

In one aspect, the present invention provides a computer-readable medium on which a program executable by a processing unit is recorded, the program, when executed by the processing unit, controlling a computer to perform the steps of: enrolling a support community formed of one or more of the authorized participants having a designated relationship to a patient that includes at least one of a member of the patient's family, friends and caregivers, who know the patient or who should be known by the patient; receiving from one or more of the authorized participants photos and identifying data uploaded to the server, wherein the photos include pictures of the patient's family, friends or others that were known by the patient; combining the photos with corresponding identifying data to form game pieces to be played with a selectable game template accessible via the server, to create a game customized and/or personalized for the patient; and permitting a collaboration among caregivers, the collaboration including a) cooperatively selecting the game templates for use by the patient b) selecting which of the photos to use in connection with the selected game template; and c) selecting a specific brain health function to exercise.

In one embodiment, wherein the steps further comprise: providing the customized game to an interface device being used by the patient and running the customized game interactively with the patient; collecting result data indicative of the patient's game playing activity; and providing results-based feedback to the community participants based upon the result data.

### BRIEF DESCRIPTION OF THE DRAWINGS

The structure, operation, and advantages of the present preferred embodiment of the invention will become further apparent upon consideration of the following description taken in conjunction with the accompanying drawings, wherein:

FIG. 1 is an overview of the Cognitive Exercise Hardware and Software System and the types of Participants within the system according to an embodiment of the invention.

FIG. 2 is an overview of the Gamification of Photos where a photo is uploaded by Participants, processed by the System to be used in game play within the system according to an embodiment of the invention

FIG. 3 is an overview of Game Play illustrating how the photos are used with respect to the selection of specific game templates within the system according to an embodiment of the invention

FIG. 3a is an example/sample of a Game Play (“Name that Photo”) illustrating what the Player would view on their device screen from MemVu within the system according to an embodiment of the invention.

FIG. 4a is an overview of the Data and Corresponding Reports that are compiled and reported to all participants in a “Summary Report” from game play within the system according to an embodiment of the inventions.

FIG. 4b is an overview of the Data and Corresponding Reports that are compiled and reported to all participants in an “Activity Report” from game play within the system according to an embodiment of the inventions.

FIG. 4c is an overview of the Data and Corresponding Reports that are compiled and reported to all participants in a “Brain Health Performance Index Report” from game play within the system according to an embodiment of the inventions.

FIG. 4d is an overview of the Data and Corresponding Reports that are compiled and reported to all participants in a “Family Caregiving Benefits Index Report” from game play within the system according to an embodiment of the inventions.

### DETAILED DESCRIPTION OF THE INVENTION

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity.

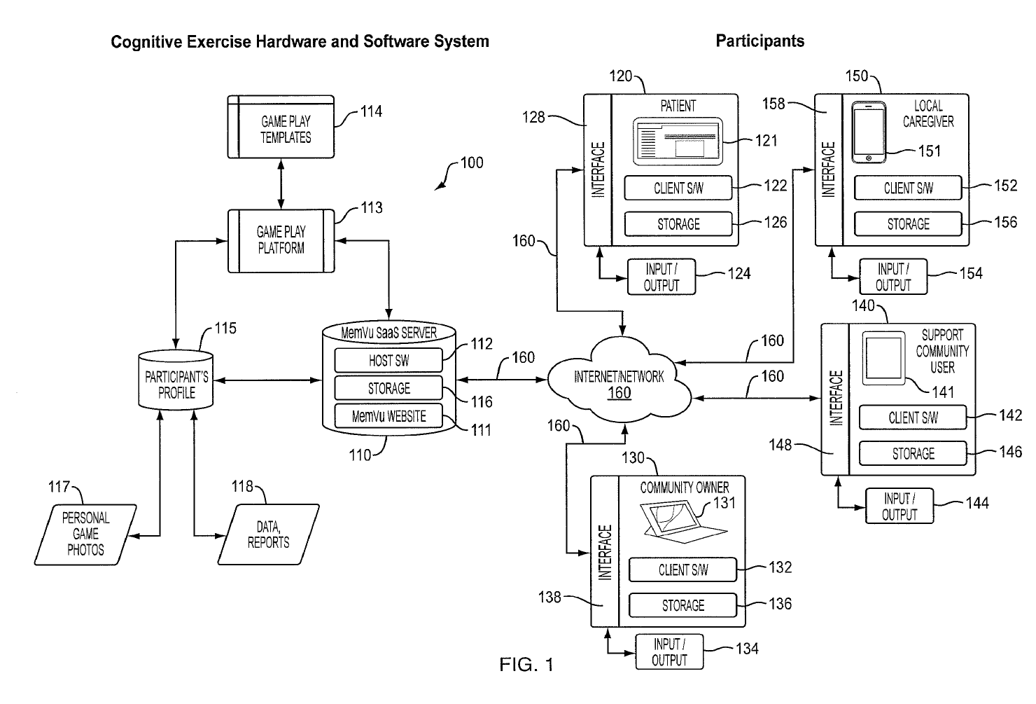

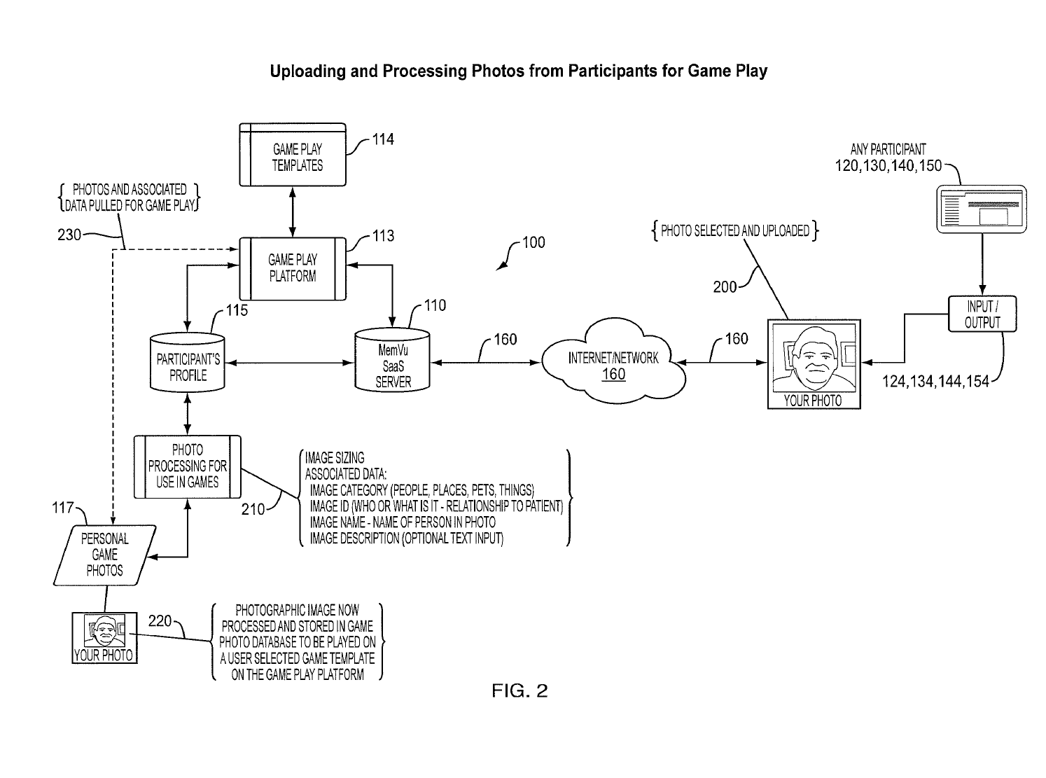

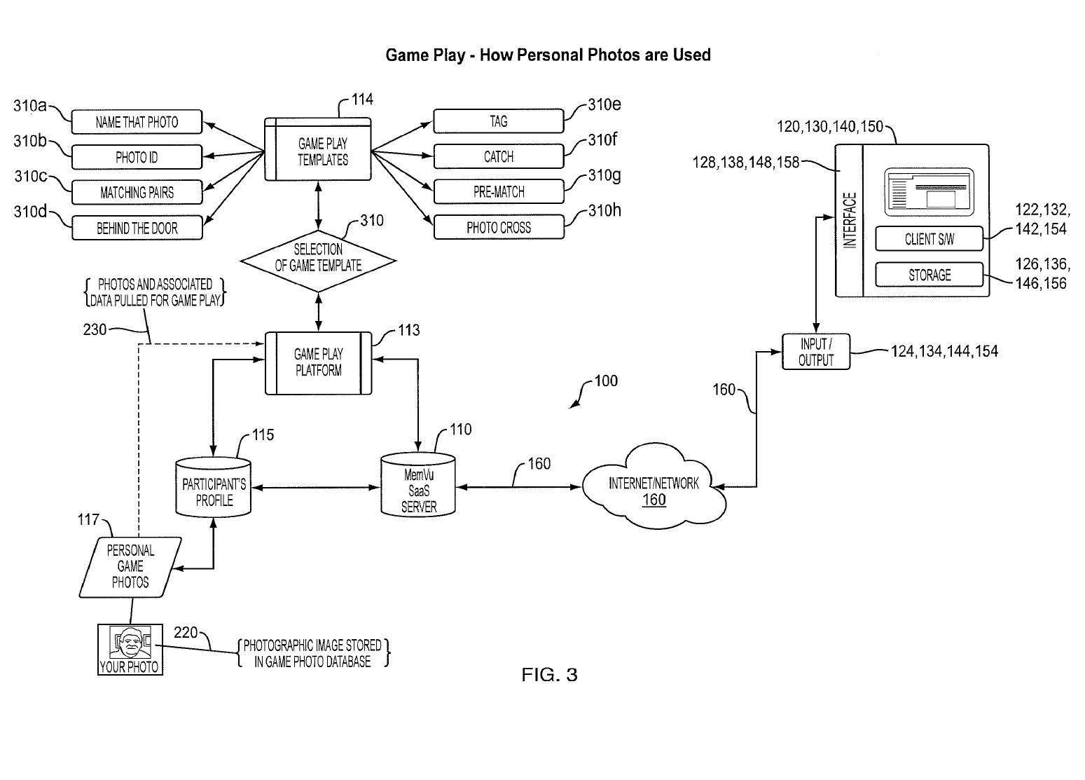

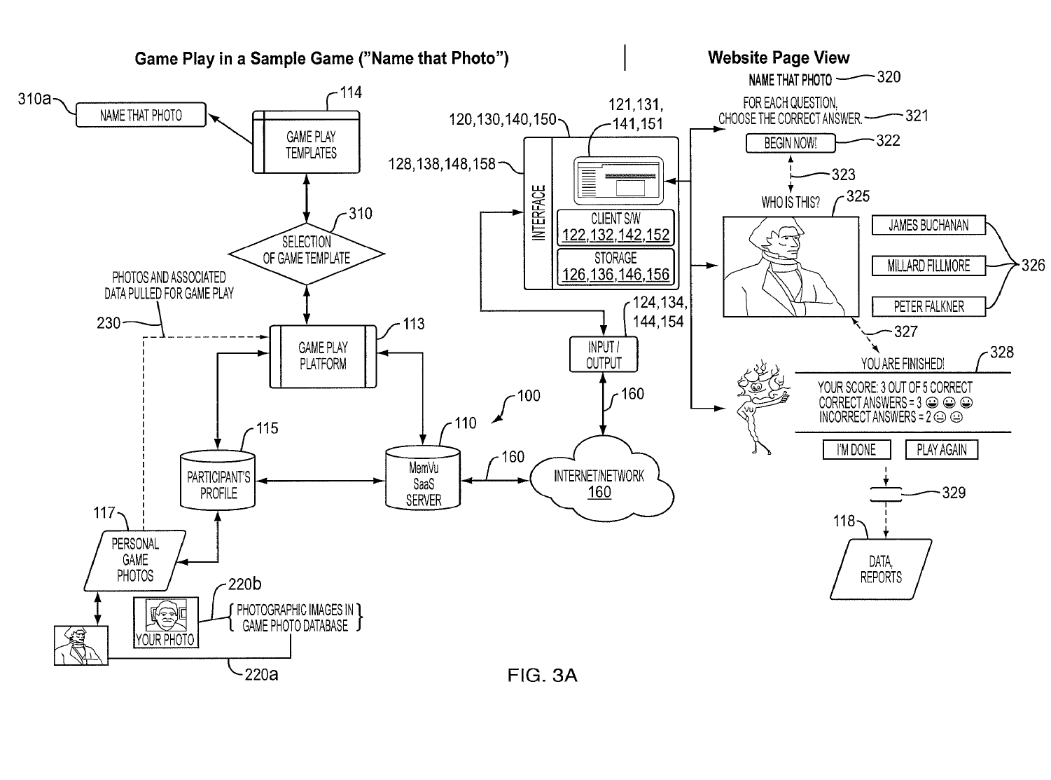

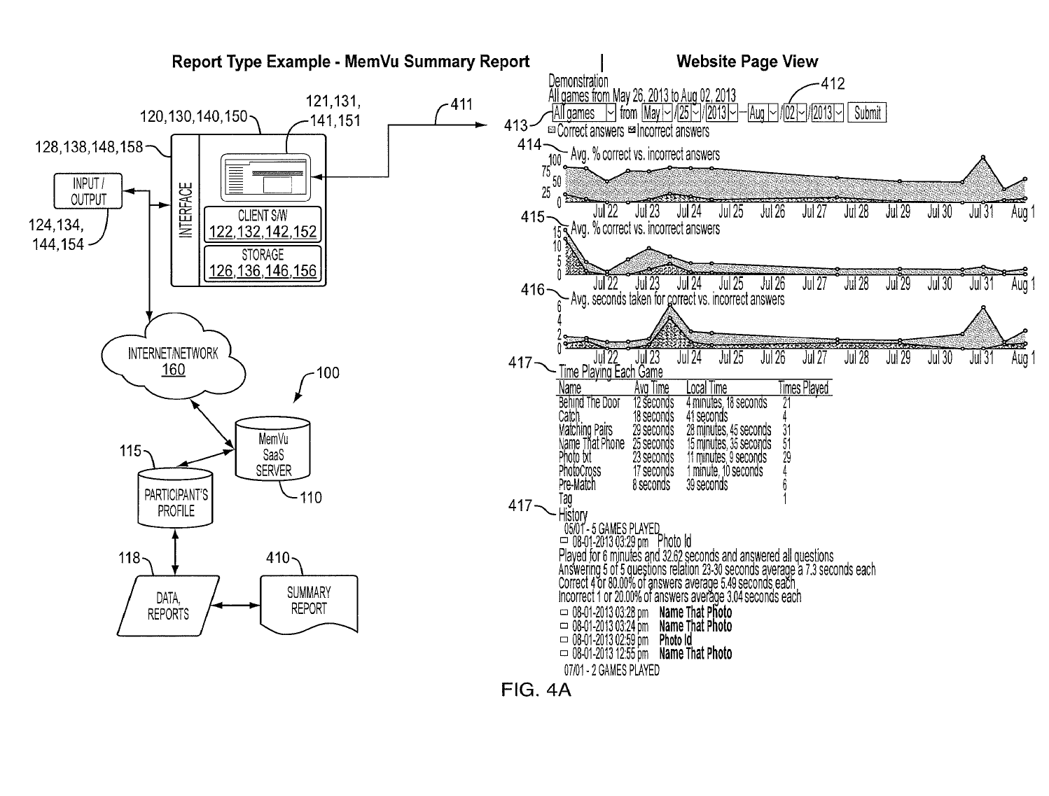

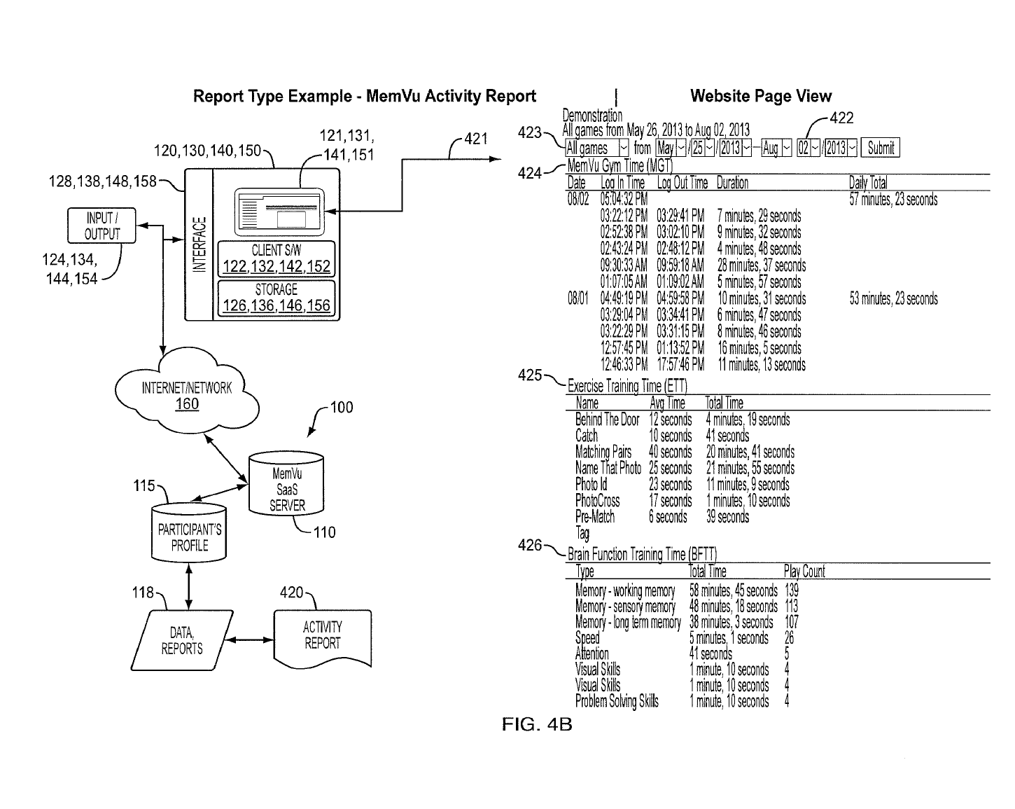

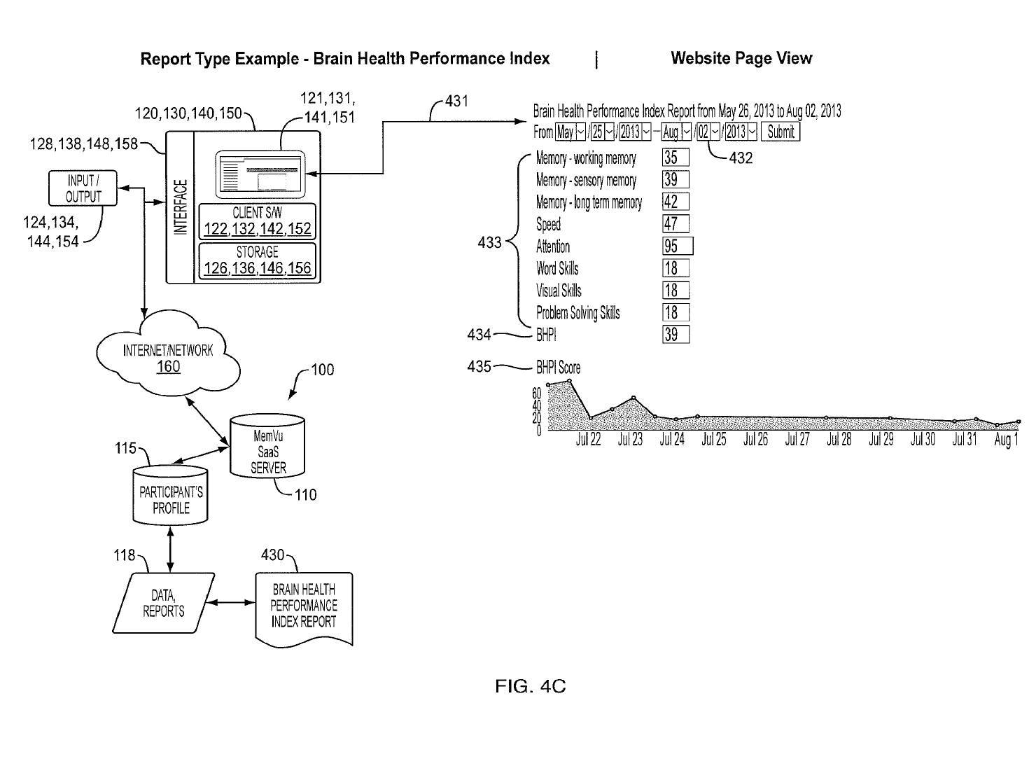

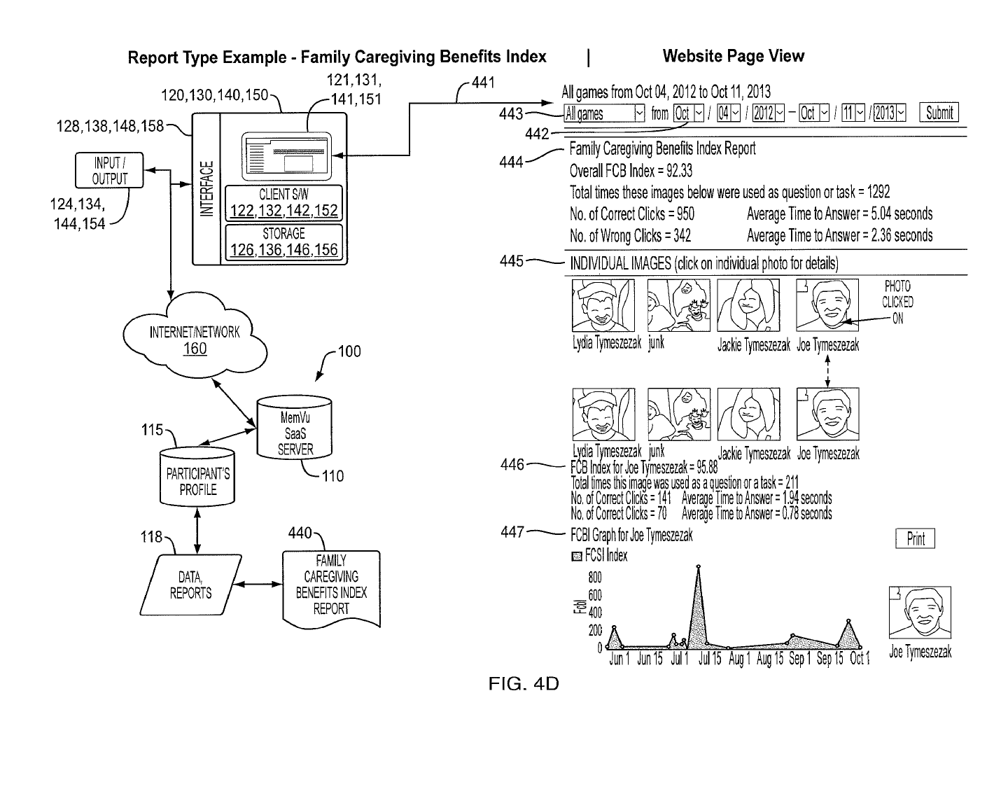

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different versions of an element 109 which are similar or related in some way but are separately referenced for the purpose of describing modifications to the parent element (109). Such relationships, if any, between similar elements in the same or different figures will become apparent throughout the specification, including, if applicable, in the claims and abstract.

| Number | Description |
|---|---|
| 1xx | HARDWARE AND SOFTWARE (SW). See FIG. 1. |
| 100 | Cognitive exercise system; MemVu system; cognitive stimulation system |
| 110 | SaaS = software as a service; web server hardware |
| 111 | MemVu website, populated and personalized by user communities |
| 112 | Host software |
| 113 | Game Play Platform |
| 114 | Game Play or Exercise/Activity Templates |
| 115 | Particpant's Profile - Access to exercise centers, reports and priveliges |
| 116 | Data storage for the host software 112 |
| 117 | Game photo database/storage |
| 118 | Database storage for data and reports |
| 120 | The Patient and or the Patient's computing device |
| 121 | Patient's website view; “brain exercise center” |
| 122 | Client software for game play |
| 124 | Input/Output |
| 126 | Data storage for game play |
| 128 | Patient's interface devices (mouse, touch screen, etc.) and display |
| 130 | The Community Creator and Owner and or their computing device |
| 131 | Owner's expanded website view with managerial control privileges |
| 132 | Owner's client software |
| 134 | Input/output |
| 136 | Data storage for support community manager |
| 138 | Owner's interface devices and display |
| 140 | The Support community and or users'/members' computing device |
| 141 | Community member's private website view: |
| 142 | Community users'/members' client software |
| 144 | Input/output |
| 146 | Data storage for community member |
| 148 | Community member's interface devices and display |
| 150 | The Local caregiver and or their computing device |
| 151 | Local caregiver's website view: may have special communication, reporting, |
| | patient interaction, and game control features. |
| 152 | Local caregiver's client software |
| 154 | Input/output |
| 156 | Data storage for local caregiver |
| 158 | Local caregiver's interface device and display |
| 160 | Cloud; Internet; World Wide Web |
| 20x | UPLOADING AND PROCESSING PHOTOS FOR GAME PLAY (See |
| | FIG. 2.) |
| 200 | Raw photo uploaded any participant (120, 130, 140, 150) |
| 210 | Photo processing and collecting associated data |
| 220 | Final photo(s) stored in game photo database 117 |
| 230 | Process of pulling photos and associated data from photo database 117 to be |
| | used on the game play platform 113 with a selected game template 114 |
| 30x | GAME PLAY - HOW PESONAL PHOTOS ARE USED (See FIGS. 3 and |
| | 3a) |
| 310 | Selection of Game Template (310a-310h) |
| 320 | Title of Game on Player's 121 screen |
| 321 | Instructions for Game on Player's screen |
| 322 | Button Display for Game to Begin on Player's screen |
| 323 | Start of Game Download |
| 324 | Display of Question asked to Player |
| 325 | Photo 220a |
| 326 | Choices (one right, two wrong) to Question 324 asked of Player |
| 327 | Selection of Choice - Correct or Incorrect |
| 328 | Display of results immediately after sequence or level completed |
| 329 | Game play results stored 118 for further reports |
| 40x | REPORTS GENERATED FROM GAME PLAY AND AVAILABLE TO |
| | ALL PARTICIPANTS (FIGS. 4a, 4b, 4c, 4d) |
| 410 | Summary Report Template (FIG. 4a) |
| 411 | Website Display of Summary Report on Participants 121, 131, 141, 151 Device |
| 412 | Date Range Selection of Summary Report 411 to display |
| 413 | Game Type Selection of Summary Report 411 to display |
| 414 | Display of Percent of questions answered correctly vs incorrectly |
| 415 | Display of Average number of questions answered correctly vs incorrectly |
| 416 | Display of Average number of seconds taken to answer questions correctly vs |
| | incorrectly |
| 417 | Display of the average and total Time playing each game and the number of |
| | times each game is played |
| 418 | Ability to view History of game play |
| 420 | Activity Report Template (FIG. 4b) |
| 421 | Website Display of Activity Report on Participants 121, 131, 141, 151 Device |
| 422 | Date Range Selection of Activity Report 421 to display |
| 423 | Game Type Selection of Activity Report 421 to display |
| 424 | Display of MemVu Gym Time - How much time is spent logged in: Date and |
| | Time |
| 425 | Display of Exercise Training Time by game type |
| 426 | Display of Brain Function Training Time and Play count by brain function |
| | category |
| 430 | Brain Health Performance Index Report Template (FIG. 4c) |
| 431 | Website Display of Brain Health Performance Index Report on Participants |
| | 121, 131, 141, 151 Device |
| 432 | Date Range Selection of Brain Health Performance Index Report 431 to |
| | display |
| 433 | Breakdown of individual Brain Health Performance Indexes by |
| | brain/cognitive function |
| 434 | Overall Brain Health Performance Index |
| 435 | Graphical display of Brain Health Performance Index over time |
| 440 | Family Caregiving Benefits Index Report Template (FIG. 4d) |
| 441 | Website Display of Family Caregiving Benefits Index Report on Participants |
| | 121, 131, 141, 151 Device |
| 442 | Date Range Selection of Family Caregiving Benefits Index Report 441 to |
| | display |
| 443 | Game Type Selection of Family Caregiving Benefits Index Report 441 to |
| | display |
| 444 | Overall Family Caregiving Benefits Index report detailing how many times |
| | personal uploaded photos display in 445 were used in games and correctly or |
| | incorrectly clicked |
| 445 | Personal photos 220 that were used in game play giving all participants the |
| | ability to click on a photo to view individual results |
| 446 | Family Caregiving Benefits Index report detailing how many times an |
| | individual photo was used in games and correctly or incorrectly clicked on |
| 447 | Graphical Family Caregiving Benefits Index report detailing how many times |
| | an individual photo was used in games and correctly or incorrectly clicked on |
| | over time. Graph with selected photo can be printed. |

At the present, the Applicant is formally entitling the memory game embodiment as “MemVu” which a federal trademark has been issued. The term “MemVu” or “MemVu.com” and terms such as game, memory game, software, hardware, platform, system, service, brain exercise center, MemVu activity center (MAC) and the like may be used interchangeably herein to refer to aspects of the invention(s) disclosed herein.

The term “Brain Exercise Center” interchangeably known as the “MemVu Activity Center” or just “Center”, refers to an aspect of the software that creates a user or patient profile from which a support community is created by inviting, via email, others into the “Center” to contribute content and view reports and data. Content, as it relates to this invention, is photographic images along with an associated description that are used in the Game Play.

The term “Community Owner”, “Community Manager”, “Community Creator” or just “Owner” and “Manager” and “Creator” are used interchangeably and refer to the individual that registered, created the exercise or activity center, invited other family members to participate and is responsible for managing the center and paying for the service to the company. The Owner can be any participant type but is designated as such, since they are the one responsible for paying for the service.

The term “family” is used in relation to the patient in the description of the present invention. In addition to the usual narrow meaning of the term, indicating the patient's close relatives (spouse, children, siblings, etc.), an extended meaning is to be understood, comprising all those who are committed to the patient's welfare or are, or were at one time, closely associated with the patient and should be well known by the him/her if it were not for memory impairment. This extended meaning may include more distant relatives, friends, business associates, unrelated caregivers who have grown close to the patient, and even pets. The terms “caregiving community”, “caregiver community”, and “support community”, which are synonymous with one another, include the family, as defined previously, as well as all professional or volunteer caregivers, some of whom may not be close to the patient.

While the term “home” primarily means the patient's permanent residence, the concept may also be intended in a broader sense to include any place of past or present residence or a place where the patient receives long-term care. For example, “home” could be a house, condo, cabin, group home, houseboat or apartment that evokes long-term memory, or a retirement, rehabilitation, nursing or similar facility in short-term memory.

The term “network” will be used to mean any network of interconnected computing devices such as desktop, laptop, and tablet computers, servers, routers, and digital storage facilities. This concept includes the Internet as well as private or public local- or wide-area networks (LAN or WAN). The word “cloud” is used to denote the equipment and channels that provide the interconnections between, and remote storage for individual computers at the end points of network branches.

The term “web page” will be used to denote a portion of a complete network or Internet website. Different types of users of a site may have access to different web pages, depending on the functions they are expected to fulfill or permitted to see. As used here, a “web page” may actually consist of more than one separately accessible electronic pages with distinct network addresses or URLs (uniform resource locators) as long as they all serve a common type of user.

There are a number of so-called “brain games” that claim to improve memory and other cognitive brain functions. On our system, a user (“Community Owner” or just “Owner”) starts by registering and creating an exercise or activity center for the individual the center is intended to be used by, along with a profile. Once the center is created, the owner can invite other family members to participate. A major difference of the cognitive exercise games of the present disclosure from these prior-art games is that it uses a patient's family (and those close to him/her) to help customize the games to uniquely suit the patient, thus optimizing and enhancing their benefits. This game customization is done by supplying content in the form of familiar photos and associated identifying information for use in the games. This kind of customization is better described by the term “personalization”. Generally, it is helpful if the “family” participants have known the patient for a long time because then, they can provide older pictures and information from the patient's past, which helps in determining the nature and extent of longer-term memory loss and compare it to short-term memory loss.

We find that contributing to the process of helping their loved one also helps build a supportive community for the family as well as the patient. This alleviates feelings of helplessness and brings members of the caregiving community some measure of reward (joy and the ability to engage their loved one), especially when the result is better recognition of them by the patient. Importantly, for the first time in this kind of patient care and support, this game concept makes good use of the family's unique knowledge of the patient, his/her history, and his/her present condition regarding memory and other cognitive brain functions. This is an important new feature to add to the tools available for care of memory-debilitated patients.

We have developed a novel software-implemented method that facilitates the use of photographs in a brain fitness/exercise program 100 whereby family pictures 200 are uploaded, processed 210 and turned into game pieces 220 to be used in a variety of cognitive exercise game templates 114 on a network-based platform presently called MemVu.com, the term “network” being defined as above. The cognitive exercise game templates 114 have an associated brain health benefit that can be tracked, for example training on short term memory as well as what we refer to as family caregiving benefits—facial recognition, currency recognition and way finding.

The upload photographs 200 that are processed 210 and turned into game pieces 220 lets the player/patient 120 engage with them as instructed by the exercise template selected 114. All game play templates 114 include game piece photos 220 in some fashion help to identify a person and indicate how the said person is related to the patient, complete a puzzle, match photographs to each other, or perform other memory-dependent activities based on the photographs. FIG. 3a illustrates playing a sample game called “Name that Photo” 310a and what the player can expect to see displayed on their device. Even if not required to answer questions about the person shown in the personalized game piece 220, simply having the image repeatedly presented during game play helps to reinforce familiarity with, and recognition of, the person. In a successful result, the game triggers the recall of memories about that person. Restoration of one or more memories is expected to serve as positive reinforcement to continue to play the game, and continued play is expected to increase the cognitive benefits.

Other game embodiments use images of money to assist with currency recognition (to identify and understand the value associated with various denominations of the dollar or other currency) or use neighborhood photographs 220 to assist in “way finding” (the ability to find the path, direction or way home). These latter two game types are designed for caregivers to use with Alzheimer's or dementia patients living at home but are still active.

The way finding games encourage a greater range of independent access inside and around the home structure, whatever it may be. By reducing disorientation and thereby the likelihood of becoming lost, a successful way finding game enhances navigation and grants better access to interior hallways, floors, rooms, closets, cupboards and cabinets as well as the home's surrounding exterior gardens, grounds and streets.

The currency recognition games are designed to reduce the stress of shopping or paying bills by restoring familiarity with relative value. It also lets family members know that their loved one understands the value of currency though reports generated by the system.

MemVu has three primary goals: to create innovative and engaging brain exercises, to get families and friends involved and connected as a community to support the patient, and to compile data to report back to family members, healthcare providers or to researchers. The personalization of game pieces 220 with family photographs is also more engaging for the creator or owner of the exercise center 130, the local caregiver(s) 150, and the friends and family members 140 of the player/patient 120, all helping to forge connections and make interactions more fun, engaging and relaxing.

### The System

Referring to FIG. 1, an exemplary combination of hardware, software and community participants is shown to schematically illustrate a typical embodiment of our cognitive exercise “system” 100. A cloud 160 based web server 110 (server hardware), and software 112 with stored 116 instructions for participants to register, create a profile 115 and create a new exercise center or participate in an existing one to use by participants 120, 130, 140, 150 in our system 100, web pages are able to provide game play downloads or views to a computing device (121, 131, 141, 151) that has an interface 128, 138, 148, 158. The patient 120 “plays the games” by interacting through the interface 128 while viewing the game play on a display 121. The patient can input 124 his/her responses by means of interface devices 128 like a mouse or a touch screen, for example. If the patient is physically unable, then a local caregiver can do the input based on the patient's verbal responses or pointing finger.

An important element is involvement of a caregiving community of family, friends and/or local caregiving professionals. All community members can interact through the internet 160 using client software 132, 142, 152 like a browser, stored 136, 146, 156 on their own computing devices 130, 140, 150. They can interact via interfaces 138, 148, 158, and preferably have some sort of means 134, 144, 154 for inputting photos which they can then upload to the server 110 for use in game piece creation 210.

### Alternative Platform

Through our research, we believe that the ideal platform (patient's computer 120) at the present time for playing MemVu is on a “tablet” style computer. A “smartphone” is generally not appropriate because the images would be too small, and the interface 128 for patient response requires fine motor control. A tablet, however, is small enough to be portable, is convenient/relatively easy to use, and is becoming inexpensive enough to make them simultaneously available for many patients, thus enabling and encouraging one-on-one engagement. The touch screen may be easier to use than a mouse for an interface 128. Networking connectivity 160 enables data collection and administration of MemVu use by caregivers wherever they are located 130, 140, 150. Thus execution of MemVu on a computing and interface platform 120, 128 like present day tablets is an embodiment that is advantageous for players/patients, the caregiving support community, and administrators.

### Gamification

To make brain fitness exercise more fun and interactive, we have added the ability to incorporate photos of friends, family, pets, familiar objects, etc. in the games. For people suffering with dementia, reinforcing these relationships has two main benefits. First, familiarity in the form of pictures can improve mood among dementia patients. The second benefit is for the family caregivers who may be at a loss to converse in a meaningful way, to feel a sense of joy and engagement. Through the game, families and friends are able to participate in the care of their loved one by playing a game and reminiscing with photos. Additionally, we can measure the degree to which the loved one with dementia is able to recognize their family, friends and caregivers. Because we are reinforcing the faces and the relationships through photos, we expect to confirm improved recognition when they come to visit after the patient has played MemVu. The use of familiar photos in the exercise games provides meaningful choices in game play, thereby increasing the benefits of playing the game while reinforcing the faces and the human relationships that are most important to the patient. FIG. 3a illustrates playing a sample game called “Name that Photo” 310a and what the player can expect to see displayed on their device.

### Data Generation and Reporting

The potential for data generated by MemVu is virtually endless as the ability to customize the data generation and the games used for that generation has no limit! The data collection opportunities with MemVu are also personalized to the individual player level. Each time a game is played, it is date and time stamped and the results are recorded. Additional measurements include: right vs. wrong answers (success rate), time to answer correctly (response speed), time to answer incorrectly, number of answers completed, and total game play time. This data allows any of the participants 120,130,140,150 to measure results over time in the areas of reaction time, decision-making, and facial recognition.

The goal in collecting data is to demonstrate an enhancement of brain fitness, engagement by participants, mood, and three benefits that are exceptionally important to the family: facial recognition of loved ones, way finding and currency recognition . . . To that end we have developed a hardware/software system that is easily customized and varied within our template/framework that uses the data generated to create four report types detailed below.

MemVu's reporting goals are to measure activity, engagement, brain health performance and to measure what is important to families as it concerns their loved ones: facial recognition, currency recognition and way finding. Participants access the Reports within the activity center simply by clicking on the reports icon to view four basic reports

1. MemVu Summary Report (FIG. 4a)

The Summary Report graphically details the percentage 414 and the number 415 of right vs wrong answers, the time taken to answer correctly and the time taken to answer incorrectly 416. The Summary Report is date range selectable 412 by any participant and is also selectable by game type 413.

Another table displayed in the Summary Report is for the “Game Playing Time”417 which details the game name, average time playing game, total time played, and number of times played. History 418 is stored by date and time and any participant can also obtain raw data output for export to any participant.

The Summary Report is one embodiment of this invention to track engagement time.

2. MemVu Activity Report (FIG. 4b)

The Activity Report looks at how long and when (date and time) participants were logged in to MemVu whether or not they were playing games, uploading photos or just viewing reports 424. The Activity Report is date range selectable 422 by any participant and is also selectable by game type 423.

The Activity Report reiterates the same Game Playing or Exercise Time 425 information from the Summary Report but includes a “Brain Function Training Time Table” 426 based on various cognitive functions assigned to each exercise template: Memory, Speed, Attention, Word Skills, Visual Skills and Problem Solving Skills (Collectively referred to as Brain Health Benefits”). When the player engages in a game the time is tracked and reported as a function of one of these cognitive functions

The MemVu Activity Report is one embodiment of this invention to additionally track engagement time based on overall use of the system and by cognitive function. Any participant can also obtain raw data output for export to any participant.

3. MemVu Brain Health Performance Index (BHPI) Report (FIG. 4c)

As previously stated, all exercise templates 114 are assigned to benefit certain cognitive functions. The Brain Health Performance Index is a formula based on the compilation of data generated from game playing. The following data is collected and a BHPI is calculated by assigning points/values based on time, correctness and level of difficulty.

### Degree of Difficulty

For each game that has multiple levels with increasing levels of difficulty, the last level completed is used as a multiplier.in this case “n=level number” to reward the player.

### Answering of Questions and Assigning Points

Correct Answer (CA)=(n*10) pts
Incorrect Answer (IA)=(n*2) pts

### No Answer (NA)=0 pts

Speed Variable (SV)=1/(answer time in seconds)

The Brain Health Performance Index (BHPI) Formula can be calculate as

(CA+IA+NA)×SV

The BHPI Report breaks out a score by individual brain or cognitive function 433 as well as an overall BHPI score 434. The BHPI is graphically illustrated over time 435. The BHPI is one embodiment of this invention to track engagement and an indication of cognitive function. Any participant can select a date range to view 432 and also obtain raw data output for export to any participant.

4. MemVu Family Caregiving Benefits Index Report (FIG. 4d)

The Family Caregiving Benefits Index is similar to the Brain Health Performance Index except that this report only examines personally uploaded photos or currency photo sets. The formula used for BHPI is applied to this data as follows

### Degree of Difficulty

For each game that has multiple levels with increasing levels of difficulty, the last level completed is used as a multiplier.in this case “n=level number” to reward the player.

### Answering of Questions and Assigning Points

Correct Answer (CA)=(n*10) pts
Incorrect Answer (IA)=(n*2) pts

### No Answer (NA)=0 pts

Speed Variable (SV)=1/(answer time in seconds)

The Family Caregiving Benefits Index (FCBI) Formula can be calculate as (CA+IA+NA)×SV. The Family Caregiving Benefits Index is a reporting tool 440 that focuses on three functions of practical benefits displaying results that are important to participants concerned about the patient's ability to recognize family members (facial recognition), the ability to understand currency (currency recognition) and the ability to navigate around their residence or finding their way back to their residence (way finding).

The MemVu Family Caregiving Benefits Index Report is one embodiment of this invention to additionally track and report on individual photos that speak to facial and currency recognition and way finding. When personal photos are uploaded and reflect the image, name and relationship to the player or a player's place of residence and/or their surroundings or landmarks, MemVu specifically tracks those photos 445, accumulates the data and displays a report 441 back to community participants based on any or all of the game template used 443 to let family members know the cognitive status of their loved one based on correctly or incorrectly clicking on familiar photos 446 based on the question asked. For example: Facial recognition of a family member (see FIG. 3a). Personal photos are uploaded with corresponding data as to the relationship and name of the person in the photo. In one of our games called “Name that Photo”, a photo of the family member is displayed with three multiple choices as to who they are. The patient then selects the answer, right or wrong, and the system reports the results in the FCBI report for that photo 446. There is also a printable graphical representation 447 of whether or not the individual photo is recognizable. This ability to determine who is in the photo is very important to families, especially when their loved one is in more advanced stages of cognitive decline and that is why this report is an important embodiment of this invention. Families want to know if their loved one still recognizes them and to manage expectations accordingly. Additionally, since all data is date and time stamp, the system and this report can identify periods of lucidity ie when is the patient most cognitively aware of their family members.

Any participant can also select a date range to view 442 and even obtain raw data output for export to any participant should it be desired.

### Benefits to Existing Data Sets and Baseline Measurement

MemVu can be used to complement existing manual assessments resources available to healthcare providers for the purpose of establishing a baseline and a continued measure of the patient's mental status. As an example, one such manual tool is the Mini-Cog assessment tool. In utilizing the Mini-Cog assessment tool, a measure of dementia, a health care provider is able to collect manual baseline information about the player's current mental status. Depending on the results, a need to administer a MMSE could arise. Results of these tools can be incorporated into dementia and mental health data sets.

MemVu also establishes a baseline that is used as a reference point to measure and report against future game plays. Once the MemVu activity/exercise center is created the first three game plays for each exercise template and for each photo type used are averaged and used as a baseline to compare to future game plays. By looking at the reports on activities and comparing it to the initial baseline, participants can monitor progression or digression over time and the possible need for further evaluation.

### Community Deployment Approach

According to an article published by A. Spector, 2003, “communication is a factor that is likely to deteriorate in individuals moving into residential care.” A definite benefit to the caregiving community we form is the increased family and social support that the elderly playing our games will receive.

In order to deploy MemVu into the community, an individualized approach will be taken with each type of facility that provides cognitive support to their constituents. When we begin the process with a long term care facility or home care company of incorporating MemVu into their care and or activity plans, we are creating a partnership to keep the family members involved and connected. This type of approach is crucial due to the variations in need between residential nursing homes, assisted living facilities, home care nurses or aides, and other types of services provided to the aging population. By taking this approach, we are able to customize data reporting for the needs of the organization while also being able to take an omniscient view of the data as a community to measure the impact of MemVu on the fore mentioned areas of observation.

Family members and/or people close to the patient, s will upload various photos that should be familiar to the patient. These “Familiar Photos” are submitted within several suggested categories along with the answer to what or who it is in the photo, and for some games also providing two relevant but wrong answers. The games themselves, photos used and answer choices should be challenging enough to stimulate brain function, but not so much as to be frustrating and unrewarding. In all cases of game play where there are increasing levels of difficulty, the player 120 is never forced to stay at level that there is no success with. In other words, the player will be redirected to the preceding level of game play in order to insure success.

Uploading and Processing Photos from Participants

When any participant 120,130,140,150 inputs/uploads 124,134,144,154 any photo 200, we need to gather some basic data and information to process 210 the photo in to a game piece 220. This process starts by determining what type of photo or category it fits into. We have identified the following photo categories as being most beneficial when used in our brain exercise games:
People—family, friends or the patient (to support facial recognition, particularly of those who will be seeing the patient)
Places—pictures of the patient's house, vacation spots, work or any other place (to help the patient with “Way Finding” i.e., finding their way back home or to other places that should be familiar.) These may be supported by pictures of related landmarks and a sketch of surrounding streets with street names.
Things—pictures of cars, sentimental objects, and money (things to be used in more analytical tests/games)
Pets—pictures of pets owned by the patient or other family members

In a simple embodiment, a session of game play involves photos being displayed to the patient for them to select right or wrong answers regarding identity of the photo. In addition to the familiar photos, a series of three or four “Standard Photos” are displayed and the patient is asked to select one of three answers to identify the standard photos as well.

For example: To start the game, a game administrator (e.g., social worker or family member) simply clicks on the Brain Game tab. When the patient/player is ready, the game administrator clicks “START”, and images are displayed with multiple choice answers to identify the photo. The participant clicks on their answer choice. If the answer is correct, a sound is generated (e.g., “Yeah! You are right.”), along with a graphical representation that they have selected the right answer (e.g., fireworks with message that “You are right”).

Several variations on this basic concept, plus some other game types are presented herein below as example embodiments for the many possible uses of the disclosed “game”.

The following description of several exemplary embodiments shows how the herein disclosed cognitive stimulation method improves patient outcomes by using a social healthcare platform with embedded diagnostic, therapeutic, and informative resources that can be adapted according to the needs of various patient types who have some form of cognitive disability.

### 1. Patient Type: Alzheimer's (Varying Stages)

Goal: Early detection and diagnosis of Alzheimer's.

Families create a MemVu Activity Center for an aging loved one early on to simply stay connected and engage with friends and children/grandchildren. {An organizational resource to store messages, photos, family contact information and/or PHR}. A family member can further encourage this individual to play family memory games frequently, because the system can collect and store data to create a “baseline” status report, which is made available to the individual or other family members for the purpose of monitoring any progression of the disease. Data can be compiled and given to a family physician to help in medical treatment. The results of this game playing can thus be used as an aid in diagnosis for the disease. Additionally, surveys can be periodically sent to check for depression or other conditions in both the patient and family members. As the disease progresses, MemVu can shift to becoming a resource to support family caregivers and help them engage with their loved one.

### 2. Patient Type: Debilitating Brain Disorders, Such as Alzheimer's, and Parkinson's, Particularly in Later Stages

Goal: Therapy, Activity and Connection Tool for a loved one in a skilled nursing facility.

Families or even a Social Worker creates a MemVu activity center for a debilitated (e.g., aging) loved one in a skilled care facility to stay connected with friends and children/grandchildren and get updates. Most skilled facilities have activities or games to engage patients. MemVu can be that activity which collects and stores data in the background. Family members can upload various photos within a game framework to use as an activity or therapy session.

### How MemVu Works

FIG. 5 are pages from a brochure/website (presently designated as MemVu.com) that explains the system to new participants. In particular it illustrates how simple it is to upload photos and to turn them into “game pieces” within a game template. In fact, the game templates are fully functional and can operate with standard photos, or (preferably) with photos submitted by community participants. The focus of effort is thus on selecting games and on determining difficulty of the games by selecting the photos to use and the identifying data to go with it.

### Examples of Our Games to Measure/Improve Cognitive Ability

These games are exemplary embodiments of variations within the scope of the present disclosure. We focus on three main categories or types of games, which are identified by the objective guiding its design and development.

### Facial Recognition Category

Name that Photo

Single Photo—Who is this? Three multiple choice answers are provided (1 correct and 2 wrong).

### Pre-Match

Pictures of a family member are displayed one at a time and the patient is asked if the current picture matches the previous one.

### Behind the Door Game

A pattern recognition game that displays a matrix of varying complexity (2×2, 3×3, 4×4, etc.) then asks the patient to click on “Bill” (a person known to patient). One, two or multiple photos of “Bill” are displayed then covered up. The Patient is asked to click on the blocks Bill is hiding behind.

### Photo ID

Three pictures of individuals are shown and the patient is asked to select the correct picture that matches the associated picture. For example, Select the photo of your grandson, Bill Tymoszcauk

### Timeline Games

Recognition of Self at different points in time/ages. Family uploads pictures of the patient at different times in their life. Patient is then asked who this person is.
Recognition of others at different points in time/ages. Family uploads pictures of themselves at different ages in their life. Patient is then asked to pick out a specific person.

### Way Finding Category

### Which Way Home

Pictures of the patient's house and surroundings, or of other familiar settings will be displayed to make sure the patient understands how to get home from the corner grocery store or even the mailbox at the top of the driveway.

### Currency Recognition and Valuation Category

### Follow the Money

Pictures of currency will be displayed with right and wrong answers. Products with dollar amounts will be displayed and the user will be asked to match the image of the currency to the product's cost.

### Monitoring Progress—The Data Gathered

In all cases, data is date-time stamped and stored. Wherever possible, we always want to reinforce the patient's recognition of the name and relationship for a family member in a photo. A scoring algorithms is be applied to each game that will feed into an overall score to measure brain health functions like memory, attention, etc. (See Reporting Section for more details within this document) We will also have a scoring mechanism applied to family caregiving—facial recognition, way finding and currency recognition.

The software will monitor key metrics (measurement data/statistics), which are then reported in appropriate and useful formats depending upon the report receiver. For example, we provide family/loved ones with graphically displayed results.

Besides family, data gathered by our system can be used by activity coordinators/social workers in a skilled care facility, and other direct care providers such as home health care workers. Gerontologists and professionals treating brain health problems or recovery from a brain injury can use it.

Improvements or degradation in familiar photos vs. standard photos may be monitored to chart results from long term memory stimulation vs. short term memory stimulation. It can also be used as a tool to monitor clinical trials of various Alzheimer drug therapies (i.e. before and after treatment), a stroke rehabilitation exercise and as a resource for skilled care facilities.

### Data Gathering & Tracking Results/Metrics/Statistics

In an embodiment, the metrics considered “key” are as follows, for both Family and Standard Photos:
Game play time
Right vs. Wrong Answers
Time Taken to Select Any Answer
Time Taken to Select Right Answer
Time Taken to Select Wrong Answer
Frequency the test was administered
Improvements or degradation in recognition of familiar photos vs. standard photos
If photos are submitted with an associated date, they can be used to determine where on a timeline the memory loss is.

### Baseline Data Gathering

A baseline set of statistics to be recorded preferably includes:
Date and time stamps for each game play session
Right vs. wrong answers
The speed at which an answer was given
the number of times the game was played
age, gender and disease condition

### Additional Data Gathering (Especially for Family Memory/Recognition Exercises)

Time to complete a right answer after the initial photo pattern is displayed
Time to complete a wrong answer after the initial photo pattern is displayed
Number of answers completed
Game play time is determined from the time they initiate game play
Current data and scoring algorithms are applied to each game that feed into an overall score to measure brain health functions like memory, attention, etc. The same data and scoring algorithms are also applicable to reports beneficial to family caregiving—facial recognition, way finding and currency recognition. The value delivered to family may only be how many times the patient/resident recognized their loved one for each exercise.
   Data from Survey Questions for Patients and Family Members

When a participant logs in, we can present them with a survey or send an email asking them how they feel. The purpose is to identify early stage symptoms of a developing mental health condition, or indications of progress or regress for the patient and/or the caregiver. Sample survey questions:
How are you feeling today? (Display icons of happy, sad, crying etc.)
Have you lost weight or gained weight?
Do you feel hopeless?
Do you feel anxious?
Have you ever thought about ending your life?
If you thought about ending your life how would you do it?

Also we can ask questions at various intervals to get a pulse on how a family caregiver and/or the patient feel (depending on the patient's condition or state of mind); and can take appropriate actions, recommend resources, or at the very least, ask them to contact their care provider.

Our concept provides a base that can be built upon as more is learned from experience with our system and from analysis of the data we gather. Further development is expected in areas such as:
Types of conditions that can benefit from use of this system;
Additional metrics useful for measuring and reporting mental/cognitive state for monitoring patient progress;
Additional types of game questions or game types (we have disclosed several that we feel are important, based on our own experience and research. Using our model, others can be added and tested for beneficial results.)

Although the invention has been illustrated and described in detail in the drawings and foregoing description, the same is to be considered as illustrative and not restrictive in character—it being understood that the embodiments shown and described have been selected as representative examples including presently preferred embodiments plus others indicative of the nature of changes and modifications that come within the spirit of the invention(s) being disclosed and within the scope of invention(s) as claimed in this and any other applications that incorporate relevant portions of the present disclosure for support of those claims. Undoubtedly, other “variations” based on the teachings set forth herein will occur to one having ordinary skill in the art to which the present invention most nearly pertains, and such variations are intended to be within the scope of the present disclosure and of any claims to invention supported by said disclosure.

1-12. (canceled)

13. A method comprising:
receiving, by a server comprising a processor, a picture and identifying data from an authorized user;
retrieving, by the server, a game template based on a brain health function to be exercised for a patient;
populating, by the server, at least a portion of the game template with the picture and identifying data;
generating, by the server, a customized game for the patient based on the populated game template; and
providing, by the server, the customized game to a computing device being used by the patient.

14. The method of claim 13 further comprising receiving, by the server, another picture and identifying data from another authorized user,
wherein the populating further comprises populating, by the server, at least another portion of the game template with the another picture and identifying data.

15. The method of claim 13, wherein the customized game comprises at least two levels of difficulty and a threshold score for reverting back to a lower level of difficulty.

16. The method of claim 13 further comprising:
receiving, by the server, data indicative of the patient's performance during the customized game; and
determining, by the server, a result for the patient playing the customized game based on the data.

17. The method of claim 16, wherein the data indicative of the patient's performance comprises at least one of a date stamp, a time stamp, an identity of the game template, a difficulty level of the customized game, a success rate for the patient, a response speed of the patient, an age of the patient, a disease state of the patient, and a gender of the patient.

18. The method of claim 16 further comprising generating, by the server, a report based on the result,
wherein the report provides results-based feedback to the authorized user.

19. The method of claim 13, wherein the brain health function is at least one of a facial recognition activity, a way finding activity, a currency recognition ability, and a monetary judgment ability.

20. The method of claim 13, wherein the picture comprises at least one of a face of a family member, a face of a friend, a face of a famous person, a pet, money, and a place.

21. The method of claim 13, wherein the authorized user is at least one of a caregiver for the patient, a family member of the patient, and a friend of the patient.

22. A system comprising:
a non-transitory memory storing computer-executable instructions; and
a processor to access the memory and execute the computer-executable instructions to at least:
receive a picture and identifying data from an authorized user;
retrieve a game template based on a selection of a brain health function to be exercised for a patient;
populate at least a portion of the game template with the picture and identifying data;
generate a customized game for the patient based on the populated game template; and
provide the customized game to a computing device being used by the patient.

23. The system of claim 22, wherein the processor further executes the computer-executable instructions to receive another picture and identifying data from another authorized user,
wherein at least another portion of the game template is populated with the another picture and identifying data.

24. The system of claim 22, wherein the processor further executes the computer-executable instructions to:
receive data indicative of the patient's performance during the customized game; and
determine a result for the patient playing the customized game based on the data.

25. The system of claim 24, wherein the data indicative of the patient's performance comprises at least one of a date stamp, a time stamp, an identity of the game template, a difficulty level of the customized game, a success rate for the patient, a response speed of the patient, an age of the patient, a disease state of the patient, and a gender of the patient.

26. The system of claim 24, wherein the processor further executes the computer-executable instructions to generate a report based on the result,
wherein the report provides results-based feedback to the authorized user.

27. The system of claim 22, wherein the brain health function is at least one of a facial recognition activity, a way finding activity, a currency recognition ability, and a monetary judgment ability.

28. The system of claim 22, wherein the picture comprises at least one of a face of a family member, a face of a friend, a face of a famous person, a pet, money, and a place.

29. The system of claim 22, wherein the authorized user is at least one of a caregiver for the patient, a family member of the patient, and a friend of the patient.

30. A non-transitory computer-readable medium having instructions stored thereon that, when executed by a processor, cause a computing device to perform the steps of:
receiving a picture and identifying data from an authorized user;
receiving a selection of a game template based on a brain health function to be exercised for a patient;
retrieving the game template based the selection;
populating at least a portion of the game template with the picture and identifying data;
generating a customized game for the patient based on the populated game template;
providing the customized game to a computing device being used by the patient.
receiving data indicative of the patient's performance during the customized game;
determining a result for the patient playing the customized game based on the data; and
generating a report based on the result,
wherein the report provides results-based feedback to the authorized user.

31. The non-transitory computer-readable medium of claim 30, wherein the steps further comprise receiving another picture and identifying data from another authorized user,
wherein at least another portion of the game template is populated with the another picture and identifying data.

32. The non-transitory computer-readable medium of claim 30, wherein the picture is familiar to the patient, including at least one of a face of a family member, a face of a friend, a face of a famous person, a pet, money, and a place.
